(19) United States
(12) Patent Application Publication
(10) Pub. No.: US 2025/0346266 A1
(43) Pub. Date: Nov. 13, 2025

(54) SYSTEMS AND METHODS FOR VISUALIZING EVENT DATA OF A CLASSIFICATION YARD

(71) Applicant: BNSF Railway Company, Fort Worth, TX (US)

(72) Inventors: Daniel E. Pittman, Kansas City, MO (US); Michael P. Lee, Shawnee, KS (US); Charles W. Morse, Anahola, HI (US)

(73) Assignee: BNSF Railway Company, Fort Worth, TX (US)

(21) Appl. No.: 18/658,556

(22) Filed: May 8, 2024

Related U.S. Application Data
(63) Continuation-in-part of application No. 18/658,386, filed on May 8, 2024.

(51) Int. Cl. B61L 27/10; B61L 27/70; G06F 9/451

(52) U.S. Cl. CPC B61L 27/10; B61L 27/70; G06F 9/451; B61L 2205/00

(57) ABSTRACT

Methods and systems for visualizing event data associated with operations of a classification yard and replaying the visualized event data in a graphical user interface. In embodiments, graphical representation of the classification yard, including its components (e.g., devices and track segments) is generated. A set of event messages is extracted from an event log, and analyzed to determine a component associated with each event message. A visual representation is generated for each event message in the set of event messages and overlaid onto the graphical representation of the component to which the event message is associated. The overlaid visual representations are replayed in a sequence according to timestamps of the visualized event messages.

### CROSS-REFERENCE TO RELATED APPLICATIONS

The present application is a Continuation-in-Part of U.S. patent application Ser. No. 18/658,386, filed on May 8, 2024, the entirety of which is herein incorporated by reference for all purposes.

### TECHNICAL FIELD

The present invention relates generally to classification yard control systems, and more particularly to visualizing event data associated with operations of a classification yard.

### BACKGROUND

A typical train is composed of one or more locomotive engines and one or more train cars being pulled and/or pushed by the one or more engines. The trains are typically assembled in a classification yard. In typical operations of a classification yard, hundreds or thousands of train cars are moved through marshalling tracks to route each of the train cars to a respectively assigned track, where the train car is coupled to its assigned train. Once the train is fully assembled, the train may leave the classification yard and travel to its destination. A particular implementation of a classification yard is a hump yard. A hump yard is a type of classification yard that uses gravity to classify train cars into their assigned train. In a hump yard, a rolling stock train that includes the train cars to be classified is pushed up the hump section (e.g., typically an elevated area, which may include and artificial or natural a hill, mound, etc.), where, as the train cars reach the crest of the hump (e.g., the top or apex of the hump) and begin rolling past the crest into the downward release section of the hump, train cars, or group of train cars, are “cut” (e.g., decoupled or separated) from the rolling stock train by gravity and begin rolling downhill away from the crest. The cuts then coast through the marshalling tracks of the hump yard and are routed to their assigned destination track where the cut is coupled to its assigned destination train.

The route that a cut follows through the marshalling tracks of a hump yard is determined by the destination train car to which the cut is assigned. In a typical hump yard, multiple destination cars may be assembled concurrently and each destination train may be positioned at a destination track of multiple destination tracks of the hump yard. The cut may be routed through the marshalling tracks to its assigned destination track.

In typical hump yard operations, the route and/or speed of the cut through the marshalling tracks may be tightly controlled in order to ensure that a proper separation distance is maintained between cuts released from the hump crest is to avoid collisions and/or damage to the various cuts. Controlling the speed of cuts is also very important to ensure that the coupling speed of the cut when it is coupled to its destination train is not too high, as this may cause damage, but also sufficiently fast to ensure that the coupling occurs. In addition, controlling the speed of cuts is also very important to ensure that the cuts maintain enough speed through their route to reach the coupling point, otherwise the cuts may stall within the marshalling tracks without making it to the destination train, which may cause operational problems and potential collisions.

Current hump yard systems use various mechanisms and/or hardware devices to control the route and/or speed of the various cuts as these various cuts travel through the marshalling tracks of the hump yard. For example, current hump yard systems may include mechanisms to regulate the speed of the hump push engine as it pushes train cars up the hump. In this manner, the speed of the hump push engine may be controlled to control the release speed of a cut. Typical hardware devices used in a classification yard may include switches that may be configured to route a cut from a source track to a target track, wheel detectors that may be configured to detect the speed and/or arrival time of a cut, retarders that may be configured to remove energy from a cut as passes through the retarders, radar devices that may be configured to detect the presence and/or speed of a cut, distance units that may be configured to detect how far a cut may be from other cuts and/or from other devices and/or points along the route from a current position), etc.

During operations of a classification yard, a large number of event messages may be generated, as each hardware device, software control module, etc., used in the operations of the classification yard may generate event messages associated with their respective operations. For example, as a cut passes through a wheel detector, the wheel detector may detect one or more wheels of the cut. For each detection, the wheel detector may generate one or more event messages indicating the detection and information related to the detection event, such as speed of the cut at the time of the detection, the particular wheel detected, etc. In another example, a switch device may generate a switch event message that may include information such as the throw position of the switch, etc. Some event messages may be generated from software control modules and may include information regarding the movements of the cut along the marshalling tracks of the hump yard such as messages indicating that a cut has entered a particular track segment (e.g., based on information from hardware devices), etc. These event messages may be compiled into an event log, and each event entry may include a timestamp indicating the time that the event was captured or generated. The event log may include thousands of messages, as in some cases, operations of a classification yard may generate thousands of messages per minute.

However, although the data in the event log may include very useful information, parsing through the data manually may present a big challenge. The sheer size of the event log may make it very difficult, if not impossible to go through the event log and make much sense of the data in the event log. Moreover, the complexity of the data may complicate its analysis, as it may be difficult to appreciate the context of a particular event entry. This may be put current classification control systems at a disadvantage, as the information in the event log may shed a lot of light into how the events relate to each other, especially in situations when operations of classification yard do not go according to expectations. For example, after a significant event (e.g., after a derailment, collision, stall event, etc.), understanding what happened prior to the event may help not only explain the cause, but may also help prevent the event from happening again. However, current systems may not be robust enough or able to implement safety processes that may significantly leverage the information in the event log due to the issues mentioned above.

### BRIEF SUMMARY

The present disclosure achieves technical advantages as systems, methods, and computer-readable storage media that provide functionality for visualizing event data associated with operations of a classification yard. In particular embodiments, features of the present disclosure may provide a system with functionality for visualizing event messages associated with operational events in an event log of operations of a classification yard and for replaying the visualized event messages in a graphical user interface (GUI) provided to an operator.

The present disclosure provides for a system integrated into a practical application with meaningful limitations as a system with functionality for visualizing a set of event messages and replaying the visualized set of event messages in a GUI. In particular embodiments, the present disclosure provides functionality for visualizing a replaying events in an event log associated with operations of a classification yard. In embodiment, a graphical representation of the classification yard, including graphical representations of the components (e.g., devices and track segments) of the classification yard, is generated. A set of event messages to be visualized and replayed is extracted from the event log, and the set of event messages is analyzed to determine a component of the classification yard associated with each event message (e.g., to determine a component at which the event that cause the event message to be generated occurred). A visual representation is generated for each message in the set of event message, and the visual representation for each message is overlaid onto the graphical representation of the component to which the event message was found to be associated. The overlaid visual representations are then replayed in a sequence according to timestamps of the visualized event messages. In this manner, functionality provided by the features of the present disclosure allow a system to overcome the deficiencies of current system which are unable to provide a contextual visualization of an event log that includes large amounts of event data associated with operations of a classification yard.

By providing functionality to visualize and replay event messages in an event log with relation to components on which the events occur, the functionality of the present disclosure provides a solution to the problems associated with the complexity and size of current event logs in classification yards. The present disclosure thus, provides a mechanism to leverage the information in the event logs in an advantageous manner that improves tracking and control systems. For example, after a significant event (e.g., after a derailment, collision, stall event, etc.), understanding what happened prior to the event may help not only explain the cause, but may also help prevent the event from happening again, which may provide a mechanism to increase the safety of operation of the system. In these cases, a system implemented in accordance with the present disclosure may be able to not only contextualize the data in the event log by providing the event messages in relation to the components at which the events occurred, but also to visualize the event logs in an improved manner that allows the system to leverage the benefits of the event log. The technological solutions provided herein, and missing from conventional systems, are more than a mere application of a manual process to a computerized environment, but rather include functionality to implement a technical process to replace or supplement current manual solutions or non-existing solutions for analyzing event logs in classification yard operations. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a system for visualizing event data associated with operations of a classification yard. It is a further object of the disclosure to provide a method of visualizing event data associated with operations of a classification yard, and a computer-based tool for visualizing event data associated with operations of a classification yard. These and other objects are provided by the present disclosure, including at least the following embodiments.

In one particular embodiment, a method of visualizing event data associated with operations of a classification yard is provided. The method includes obtaining a set of event messages from an event log associated with operations of the classification yard. In embodiments, each event message in the set of event messages may represent an event that occurred during the operations of the classification yard. The method also includes generating, for each event message of the set of event messages, a visual representation of the event that occurred during the operations of the classification yard represented by each respective event message of the set of event messages and generating a graphical schematic diagram of the classification yard. In embodiments, the graphical schematic diagram includes a graphical representation of one or more components of the classification yard. The method further includes determining, for each event message of the set of event messages, a component of the one or more components of the classification yard with which each respective event message is associated, and replaying the set of event messages in a graphical user interface (GUI). In embodiments, replaying the set of event messages includes overlaying each visual representation of an event represented by a respective event message onto the graphical representation of a component determined to be associated with the respective event message.

In another embodiment, a system for visualizing event data associated with operations of a classification yard is provided. The system comprises at least one processor and a memory operably coupled to the at least one processor and storing processor-readable code that, when executed by the at least one processor, is configured to perform operations. The operations include obtaining a set of event messages from an event log associated with operations of the classification yard. In embodiments, each event message in the set of event messages may represent an event that occurred during the operations of the classification yard. The operations also include generating, for each event message of the set of event messages, a visual representation of the event that occurred during the operations of the classification yard represented by each respective event message of the set of event messages and generating a graphical schematic diagram of the classification yard. In embodiments, the graphical schematic diagram includes a graphical representation of one or more components of the classification yard. The operations further include determining, for each event message of the set of event messages, a component of the one or more components of the classification yard with which each respective event message is associated, and replaying the set of event messages in a GUI. In embodiments, replaying the set of event messages includes overlaying each visual representation of an event represented by a respective event message onto the graphical representation of a component determined to be associated with the respective event message.

In yet another embodiment, a computer-based tool visualizing event data associated with operations of a classification yard is provided. The computer-based tool including non-transitory computer readable media having stored thereon computer code which, when executed by a processor, causes a computing device to perform operations. The operations include obtaining a set of event messages from an event log associated with operations of the classification yard. In embodiments, each event message in the set of event messages may represent an event that occurred during the operations of the classification yard. The operations also include generating, for each event message of the set of event messages, a visual representation of the event that occurred during the operations of the classification yard represented by each respective event message of the set of event messages and generating a graphical schematic diagram of the classification yard. In embodiments, the graphical schematic diagram includes a graphical representation of one or more components of the classification yard. The operations further include determining, for each event message of the set of event messages, a component of the one or more components of the classification yard with which each respective event message is associated, and replaying the set of event messages in a GUI. In embodiments, replaying the set of event messages includes overlaying each visual representation of an event represented by a respective event message onto the graphical representation of a component determined to be associated with the respective event message.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an exemplary system configured with capabilities and functionality for visualizing event data associated with operations of a classification yard in accordance with embodiments of the present disclosure.

FIG. 2 shows an example of a portion of an event log implemented in accordance with embodiments of the present disclosure.

FIG. 3 shows an example of a communications module implemented in accordance with embodiments herein.

FIG. 4A show an example of a graphical user interface (GUI) configured to visualize and replay event messages in accordance with embodiments of the present disclosure.

FIG. 4B shows an example of a graphical schematic diagram of a classification yard configured in accordance with embodiments of the present disclosure.

FIG. 4C shows an example of an overlay of a visual representation of an event over the components associated with the event in accordance with embodiments of the present disclosure.

FIG. 4D shows another example of an overlay of a visual representation of an event over the components associated with the event in accordance with embodiments of the present disclosure.

FIG. 5 shows a high-level flow diagram of operation of a system for providing visualization of event data associated with operations of a classification yard in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Various embodiments of the present disclosure are directed to systems and techniques that provide functionality for visualizing event data associated with operations of a classification yard. In particular embodiments, features of the present disclosure may provide a system with functionality for visualizing data entries associated with operational events in an event log of operations of a classification yard and replaying the visualized data entries in a graphical user interface provided to an operator. For example, in embodiment, a graphical representation of the classification yard, including graphical representations of the components (e.g., devices and track segments) of the classification yard, may be generated. A set of event messages to be visualized and replayed may be extracted from the event log, and the set of event messages may be analyzed to determine a component of the classification yard associated with each event message (e.g., to determine a component at which the event that cause the event message to be generated occurred). A visual representation may be generated for each message in the set of event message, and the visual representation for each message may be overlaid onto the graphical representation of the component to which the event message was found to be associated. The overlaid visual representations may be then replayed in a sequence according to timestamps of the visualized event messages. In this manner, functionality provided by the features of the present disclosure allow a system to overcome the deficiencies of current system which are unable to provide a contextual visualization of an event log that includes large amounts of event data associated with operations of a classification yard.

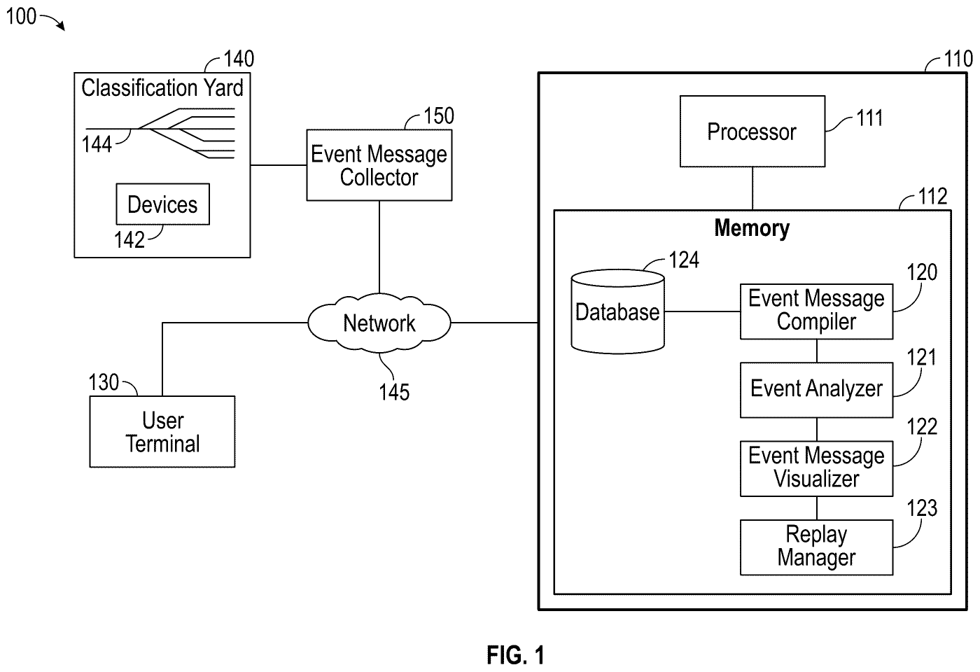

FIG. 1 is a block diagram of an exemplary system 100 configured with capabilities and functionality for visualizing event data associated with operations of a classification yard in accordance with embodiments of the present disclosure. As shown in FIG. 1, system 100 may include server 110, classification yard 140, event message collector 150, user terminal 130, and network 145. These components, and their individual components, may cooperatively operate to provide functionality in accordance with the discussion herein.

It is noted that the present discussion focuses on a particular application of visualizing event data that involves visualization of event data associated with operations in a classification yard for routing cuts through marshalling tracks of the classification yard (e.g., a train yard, a hump yard, etc.). However, it should be appreciated that the techniques disclosed herein may also be applicable to other applications of event data visualization. As such, the discussion herein with respect to visualization of event data associated with operations in a classification yard for routing cuts through marshalling tracks of the classification yard should not be construed as limiting in any way.

In embodiments, the functional blocks, and components thereof, of system 100 of embodiments of the present invention may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

Classification yard 140 may represent a train yard, such as a hump yard, in which train cars are routed or marshalled to a destination track to be coupled to a destination train. In a typical operation of classification yard 140, such as a hump yard, a stock train that includes train cars to be marshalled to their assigned train may be pushed by a hump push engine at a push speed along the approach section of the hump to the crest of the hump. As the train cars roll past the hump crest, gravity may begin pulling the train cars towards the bottom of the hump. In embodiments, the train cars are “cut” from the stock train and the cut is allowed to roll down the hump and is marshalled to the destination train along a route through the marshalling tracks of the hump yard. In embodiments, classification yard 140 may include functionality to plan, track, control, and report the movement of the train cars through the marshalling tracks, including the hump approach section, the hump crest, the hump release area, and multiple marshalling tracks.

As noted above, ensuring that the cut reaches the assigned destination train at the appropriate coupling speed is very important. As such, in embodiments, a cut may be tracked and controlled as the cut moves along the marshalling tracks of classification yard 140. In particular, the route and the speed of the cut from the hump to its destination track or train may be controlled using various components of classification yard 140. For example, classification yard 140 may include various components enabling classification yard 140 to track and/or control the movement of a cut through the marshalling tracks.

In embodiments, the various components enabling classification yard 140 to track and/or control the movement and/or speed of a cut through the marshalling tracks may include devices 142 and segments 144, which may include hardware devices such as switches, retarders, radars, wheel detectors, distance units, identification devices, etc. In embodiments, the cooperative operation of the various components of classification yard 140 may enable classification yard 140 to ensure that various cuts traverse the marshalling tracks and arrive at the destination coupling point at the appropriate coupling speed.

In embodiments, a switch device may be configured to route a cut from a source track to a target track. A switch may be thrown from a first position (e.g., corresponding to a first track) to a second position (e.g., corresponding to a second track) in order to route a cut passing through the switch from a source track to the second track, the second track being the target track of the cut. In this manner, switches may be used to control the route of a cut as it travels through the marshalling tracks.

A wheel detector may be configured to detect a speed of a cut by detecting the presence of a first wheel of the cut at a first time, detecting the presence of a second wheel of the cut at a second time, and determining a speed from the difference between the first and second times over the known distance between the first wheel and the second wheel. In embodiments, a radar device may be configured to detect the presence of a cut and/or to measure the speed of the cut traveling through the detection area of the radar devices. In this manner, wheel detectors and/or radars may be used to measure the speed and/or presence of cuts as the cuts move through the hump yard. In some embodiments, a device may include a combination of devices, such as a switch wheel detector, which may be configured to perform operations related to switch operations and wheel detector operations. In this manner, a switch wheel detector may be configured to route a cut to a target track and to detect the wheels of the cut (e.g., for speed measurement operations).

A retarder may be configured to slowing down a cut as the cut travels through the. A retarder may be configured to apply a pressure against one or more wheels of the cut (e.g., using a braking element, such as a brake pad, etc.), which may cause the cut to slow down. In this manner, retarders may be used to further control the speed of a cut as it travels through the marshalling tracks of the hump yard.

In embodiments, distance units that may be configured to detect how far a current location of a cut within the hump yard may be from other cuts, from other devices, and/or from other points along the cut's route. In some embodiments, distance units may be used to measure a distance. In embodiments, identification devices may be configured to detect an identification of a cut, such as via radio frequency identification (RFID) devices. Identification devices may be used to identify cuts as the cuts travel through the marshalling tracks of the hump yard.

In embodiments, devices 142 may include occupancy devices that may include track circuits, light detectors, presence detectors, etc., and may be configured to detect occupancy of a track and/or track segment, such as to detect a presence of a vehicle within the track and/or track segment. In some embodiments, occupancy devices may be configured to detect when a track or track segment has been filled to a safe capacity, which may enable a system to prevent overfilling of the track or track segment. In embodiments, occupancy devices may be used in long sections of track that may not include a wheel detector, a retarder, etc. In embodiments, an occupancy device may be configured with predicted on and off times. If the on and off times are exceeded, a segment protected by the occupancy device may be temporarily protected and if the condition persists, the protection may remain. In embodiments, protecting a track or track segment may include routing away from the protected track or track segment, such as in response to a determination that sufficient time exists to route the vehicle away from the protected track or track segment. However, the railroad vehicle may be routed into the protected track segment (e.g., to prevent a side-swipe) in response to a determination that there is not sufficient time to route the vehicle away from the protected track or track segment.

In embodiments, the various devices in devices 142 may be positioned at different locations or points within the layout of the classification yard. In embodiments, the position of the various devices in devices 142 may be determined based on the layout of the track segments (e.g., segments 144) making up the marshalling tracks of classification yard 140. For example, a first retarder may be positioned along the release section of the hump, whereas a second retarder may be positioned along a different segment. In embodiments, wheel detectors and/or switches may be positioned at the entry point of each track segment within classification yard 140.

For example, the marshalling tracks of classification yard 140 may be divided into a plurality of segments (e.g., segments 144). In embodiments, each of segments 144 may be defined by an entry point and an exit. In some embodiments, the entry point and/or the exit point of a segment may correspond to a device (e.g., a switch, a retarder, a detector, etc.) of classification yard 140. In this manner, devices may be used to divide the marshalling tracks of classification yard 144 into segments 144. In embodiments, a route followed by a cut may be defined by a connection of various segments of segments 144 that may route the cut from the hump section to the assigned destination track. In some embodiments, a segment may include one or more devices within the segment. For example, a segment may include one or more retarders, one or more switches, one or more detectors, within the boundaries of the segment (e.g., in addition to the entry and/or exit point devices of the segment). In some embodiments, segments may be defined by geographical features.

Data collector 150 may be configured to capture and store (e.g., in a database, such as database 124) event messages generated during operations of classification yard 140. For example, during operations of classification yard 140, various events may occur at the various components (e.g., devices, segments, software modules, etc.) of classification yard 140. The various events may include operational events occurring at the various components of classification yard 140, such as switch activations, wheel detections, retarder operations, cut speed measurements, notifications, a segment being occupied, a segment being cleared, a protection event, a route calculation for a cut, and/or many other types of events. In embodiments, an event may include any operational event, action, operation, etc., that may be performed or may occur at a component (e.g., a device, segment, software module, etc.) of classification yard.

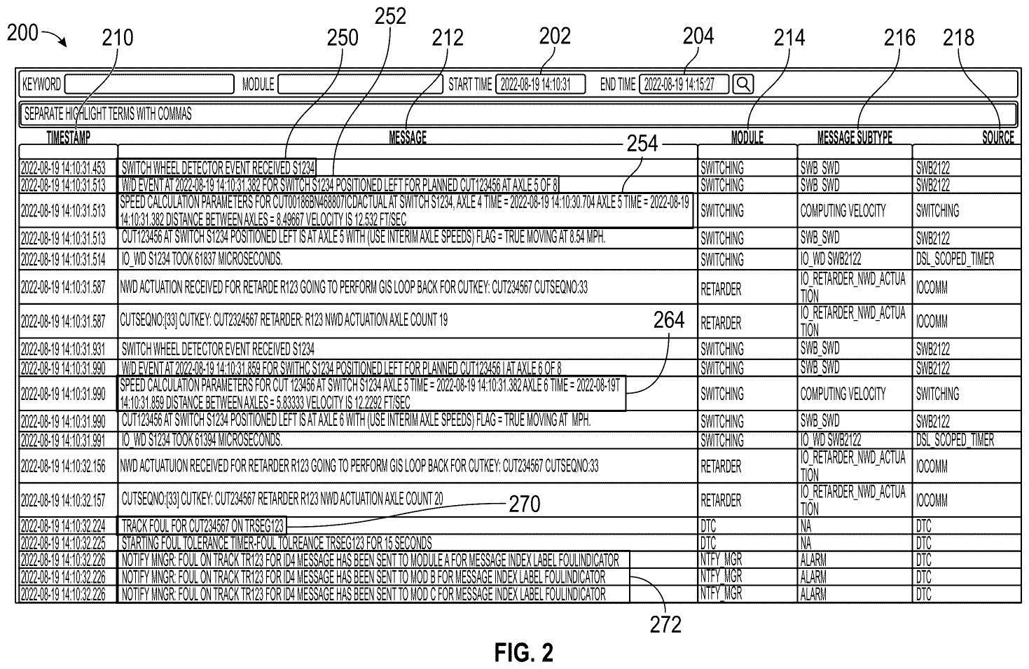

In embodiments, the event messages may be stored as an event log, in which each event message may be an entry into the event log. FIG. 2 shows an example of a portion of an event log implemented in accordance with embodiments of the present disclosure. In the example illustrated in FIG. 2, a portion of event 200 may be illustrated. In embodiments, an event message may include a timestamp (e.g., shown in timestamp section 210 of event log 200), which may include a timestamp (e.g., date and time) at which the event associated with the event message occurred. In some embodiments, the timestamp at section 210 may represent a date/time at which the event message was generated and stored in event log 200 (e.g., rather than the time at which the event associated with the event message occurred).

In embodiments, an event message may include a message 212. In embodiments, message 212 may include a description and/or information related to the nature of the event associated with the event message (e.g., the event that caused the generation of the event message). For example, event message 250 may include a message indicating that the event associated with event message 250 is a wheel detection event occurring at a switch/wheel detector device. In this example, the message of event message 250 may indicate an identification of the switch/wheel detector device at which the event occurred. In this manner, a wheel detection event, which may include a wheel passing through a switch/wheel detector, may have caused generation of event message 250. As can be seen in event log 200, however, the wheel detection event that caused the generation of event message 250 may also cause generation of additional event messages. For example, event message 252 may have also been generated due to the wheel detection event occurring at the switch wheel detector. In this manner, event message 250 and 252 may both be associated with the wheel detection event. As can be seen in this example, the message of event message 252 may include a message indicating that the event associated with event message 250 is a wheel detection event occurring at a particular time, an identification of the switch device, an indication of the position at which the switch wheel detector was at (e.g., LEFT in this example), an identification of the cut to which the detected wheel belonged, and an identification of the specific wheel detected (e.g., in this example, wheel 5 of 8 was the wheel detected in the wheel detection event, which may indicate that the identified cut has eight wheels total.

As can be further seen in the example illustrated in FIG. 2, event message 252 may be associated with a speed calculation event. In this example, the wheel detection event (e.g., the wheel detection event associated with event messages 250 and 252) may cause a speed calculation event to occur at the switch wheel detector device. In this case, as can be seen from the message of event message 254, the speed calculation event may include a speed calculation that is based on the values obtained from the wheel detection event. In this example, the parameters for the speed calculation may include the time at which the fifth wheel of the cut was detected, but may also include the time at which the previous fourth wheel was detected. A distance between the fourth and fifth wheel may be known, and a speed calculation that includes dividing the difference between the time of the fifth wheel detection and the fourth wheel detection over the distance between the fourth and fifth wheel. In this case, the message of event message 254 may include the speed of the cut as measured during event message 252. It is noted that, event message 264 is a similar speed calculation that is performed, but on an event related to the detection of the sixth wheel of the same cut as the above example. In this case, a similar calculation may be performed to obtain the speed of the cut during the detection of the sixth wheel, and the speed is included in the message of event message 264.

Further in the example illustrated in FIG. 2, event log 200 may include event message 270, which may be associated with a notification event. In embodiments, notification events may include notifications that may be generated by specific events in the operations of classification yard 140. In embodiments, notification events may be classified by severity. For example, critical notification events may include notifications that must be acknowledged by an operator within a configurable time limit. If a critical notification is not acknowledged by the operator, a “stop hump” signal may be generated, which may include a signal to stop all or some operations of the hump yard. Non-critical notification events which may include notifications that are for informational purpose and may not require acknowledgment from the operator. In embodiments, notification messages may be configured to be distributed to operators based on user role. In this manner, a message for a notification event may include an indication of the severity of the notification message, the event that generated the notification event, and/or an indication of an entity or role for whom the notification is to be sent. For example, event message 270 may be critical notification indicating that a track foul occurred in a segment of the classification yard. Event messages 272 may include events in which the critical notification that generated event message 270 may be sent to respective entities. In embodiments, critical and non-critical notifications may be configurable and may be overridden to forego the generation of a “stop hump” signal, even for critical notifications.

It is noted that many different types of event messages may be included in event log 200. The examples discussed herein are for illustrative purposes to describe the functionality of event log 200. However, the description herein should not be construed as limiting in any way.

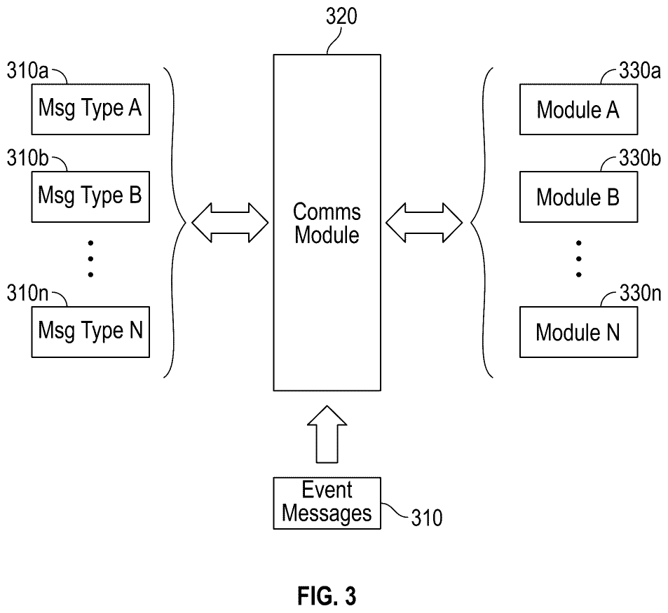

In embodiments, the configuration of data collector 150 to capture the event messages and compile them into the event log may be facilitate by a communications module, as illustrated in FIG. 3. FIG. 3 shows an example of a communications module 320 implemented in accordance with embodiments herein.

In embodiments, communication module 320 may be configured to marshal event messages to the appropriate handling module based on a type of message. For example, message events may be classified into one of a plurality of message types. Communications module may be configured to receive event messages (e.g., event messages 310) generated by various components of classification yard 140, to classify the event messages as a message type (e.g., one of message types 310a-310n) based on source of each event message, and to determine a handling module (e.g., one of handling module 330a-330n) responsible for handling a respective type of an event message. In embodiments, a handling module responsible for handling a respective type of an event message may be configured to process the event message, identify the event associated with the event message, and identify one or more components associated with the event. In some embodiments, the message type of an event message may be based on the source of the event and/or of the message event. For example, with additional reference to FIG. 2, source 218 of event message 250 may be the switch wheel detector at which the event (e.g., the wheel detection event) that caused the generation of event message 250 occurred. In this case, communications module 320 may be configured to receive event message 250 and, based on the source of event message 250, may determine that a module responsible for handling switching events (including switch event messages) may be a switching module (e.g., as indicated in module indication 214. In embodiments, an event message sub-type 216 my also be determined by communications module 320, such as based on the specific details of the event. For example, event message 250, which is associated with a wheel detection event, may be determined to have a message subtype of a first type, while event message 254, which is associated with a speed calculation event based on a wheel detection, may be determined to have a message subtype of a first type (e.g., computing velocity).

In embodiments, data collector 150 may be configured to capture the event messages, compile the messages into the event log, and store the event log into a database (e.g., database 124).

With reference back to FIG. 1, user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide configuration parameters that may be used by system 100 to provide functionality for performing visualization of event data associated with operations of classification yard 140, such as by specifying configuration parameters which and how event data is to be presented to the operator in the visualization. In embodiments, user terminal 130 may be configured to communicate with other components of system 100.

In embodiments, server 110, classification yard 140 (and its various components), event message collector, and user terminal 130 may be communicatively coupled via network 145. Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Server 110 may be configured to facilitate operations for determining a status of switch devices in a classification yard in accordance with embodiments of the present disclosure. In embodiments, functionality of server 110 to facilitate determination of a status of switch devices in a classification yard may be provided by the cooperative operation of the various components of server 110, as will be described in more detail below.

Although FIG. 1 shows a single server 110, it will be appreciated that server 110 and its individual functional blocks may be implemented as a single device or may be distributed over multiple devices having their own processing resources, whose aggregate functionality may be configured to perform operations in accordance with the present disclosure. Furthermore, those of skill in the art would recognize that although FIG. 1 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 1, server 110 includes processor 111, memory 112, database 124, event message compiler 120, event analyzer 121, event message visualizer 122, and replay manager 123. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 124 for storing various information related to operations of system 100. For example, database 124 may store analysis models, threshold data, configuration information, etc., to be used for configuring system 100, etc. In embodiments, database 124 may also operate to store an event log including the event messages generate by operations of classification yard 140. In embodiments, the event log may be stored as a single file, or may be distributed over several event logs and/or files. In embodiments, database 124 may also operate to graphical schematic diagrams including a graphical representation of classification yard 140 including graphical representations of the various components of classification yard 140, as well as visual representations of events associated with event messages to be overlaid upon the graphical representations of the classification yard, as will be described in more detail below.

Database 124 is illustrated as integrated into memory 112, but in some embodiments, database 124 may be provided as a separate storage module or may be provided as a cloud-based storage module. Additionally, or alternatively, database 124 may be a single database, or may be a distributed database implemented over a plurality of database modules.

Event message compiler 120 may be configured to retrieve a set of event messages stored in the event log from database 124 according to configurable parameters. In embodiments, each event message in the set of event messages retrieved by event message compiler 120 may be associated with an event that occurred during operations of classification yard 140. For example, as previously noted, an event may include events that may occur at the various components (e.g., devices, segments, software modules, etc.) of classification yard 140, and may include operational events occurring at the various components of classification yard 140, such as switch activations, wheel detections, retarder operations, cut speed measurements, notifications, a segment being occupied, a segment being cleared, a protection fault, a route calculation for a cut, and/or many other types of events. These events may cause event messages to be generated and the events messages may be stored in the event log in database 124. Event message compiler 120 may be configured to connect to database 124 and retrieve the event log to retrieve a set of event messages from the event log based on configuration parameters.

In embodiments, the configuration parameters may be predetermined and may be obtained by event message compiler 120 from database 124. In some embodiments, the configuration parameters may be specified by an operator during operation of system 100 to visualize event data in accordance with embodiments of the present disclosure. For example, in embodiments, a GUI may be provided (e.g., via user terminal 130) to an operator, via which the operator may specify various of the configuration parameters that event message compiler 120 may use to compile the set of event messages.

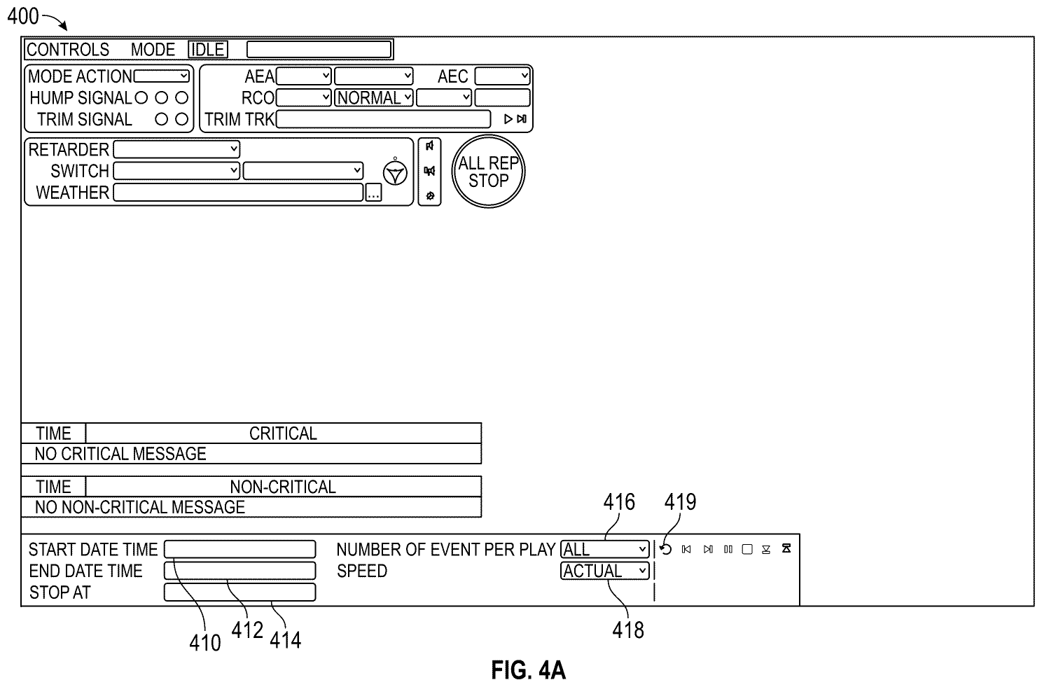

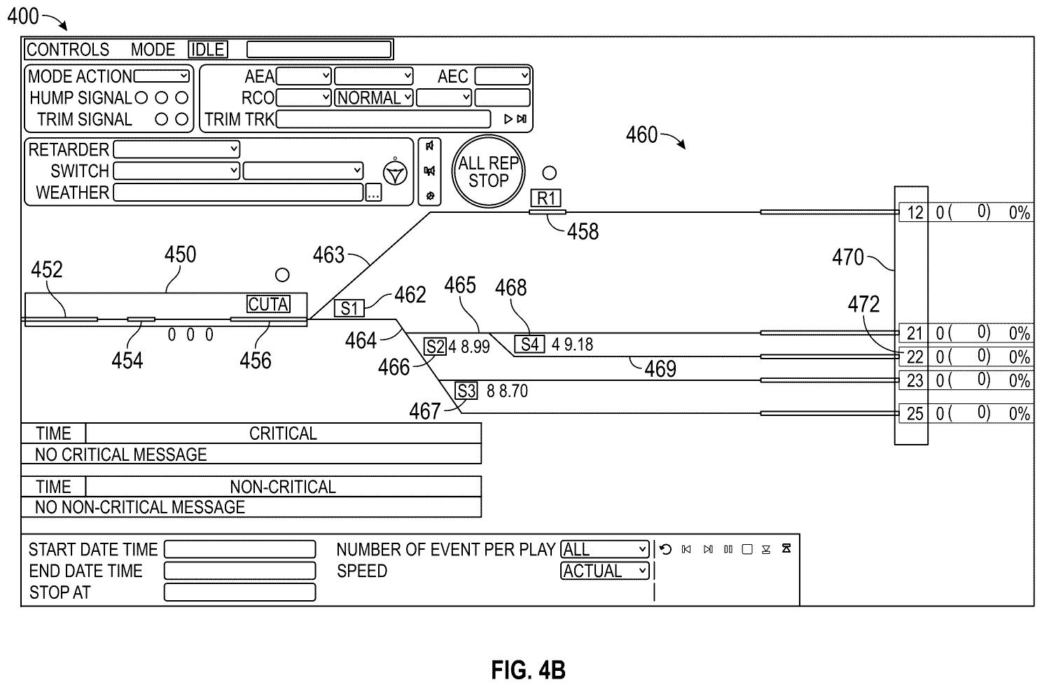

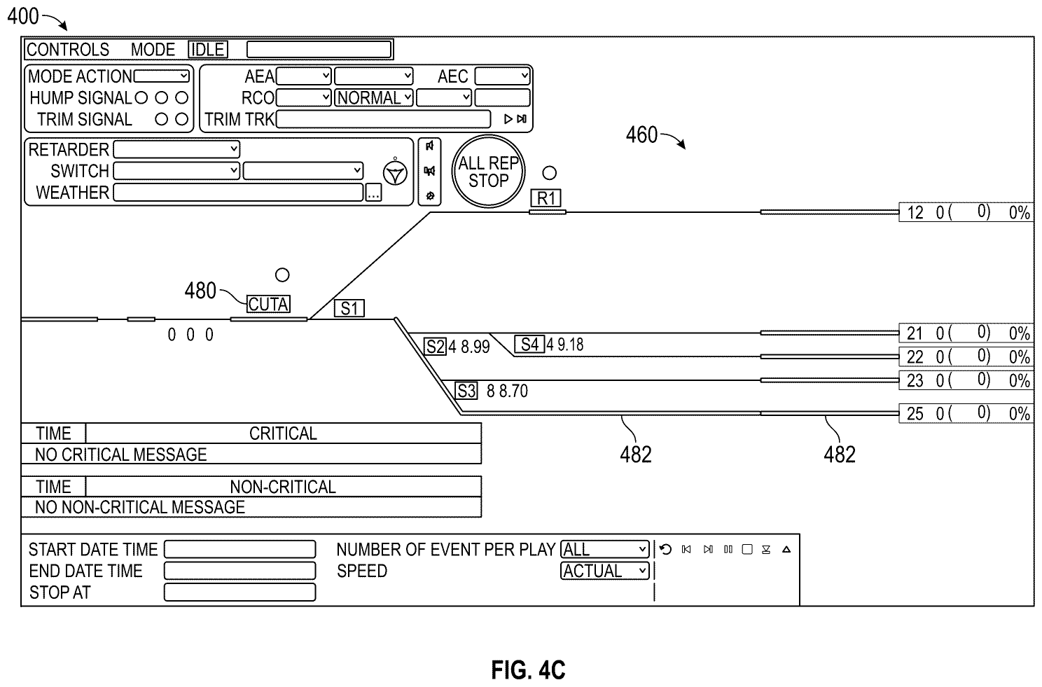

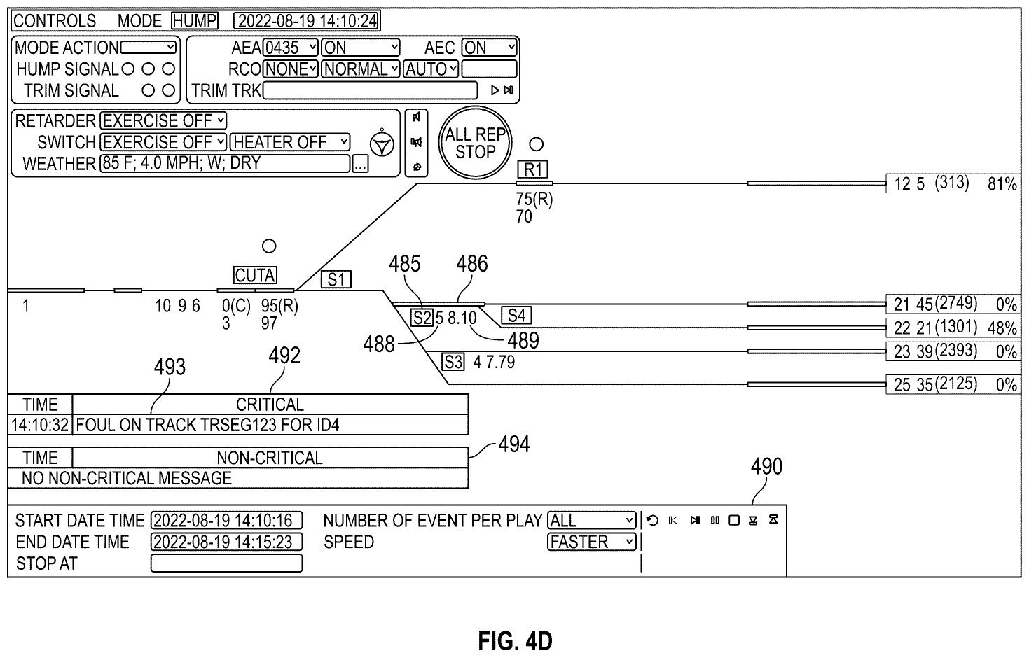

FIG. 4A show an example of a graphical user interface (GUI) 400 configured to visualize and replay event messages in accordance with embodiments of the present disclosure. In particular, FIG. 4A shows GUI 400 as including graphical control elements that provide functionality for an operator to specify various of the configuration parameters that event message compiler 120 may use to compile the set of event messages to be visualized. For example, GUI 400 may include start date/time control element 410 to enable an operator to specify a start date/time threshold for event messages to be compiled in the set of event messages. In this case, event messages with a timestamp earlier than the start date/time may not be included in the set of event messages, but event messages with a timestamp equal to or later than the start date/time may be included in the set of event messages. GUI 400 may also include stop date/time control element 412 to enable the operator to specify a stop date/time threshold for event messages to be compiled in the set of event messages. In this case, event messages with a timestamp later than the stop date/time may not be included in the set of event messages, but event messages with a timestamp equal to or earlier than the stop date/time may be included in the set of event messages. In this manner, start date/time control element 410 and stop date/time control element 412 may enable an operator to specify a date/time range for events to be retrieved by event message compiler 120 for visualization and replay.

In embodiment, GUI 400 may also include element 414 to enable the operator to specify a keyword upon which a replay of visualized event messages may stop or pause. For example, an operator may specify a keyword of “error” in element 414. In this case, although event message compiler may compile a set of event messages to be visualized and replayed in accordance with embodiments of the present disclosure, upon replaying, system 100 may pause the replay of the visualized event messages upon encountering an event message that includes the keyword “error.” In this manner, element 414 may provide the operator a control mechanism to control the replaying of the visualized event messages, such as to aid in research and investigation of operations of the yard (e.g., research and investigation of incidents). In embodiments, periodic snapshots of status may be obtained. Each of the snapshots may be associated with an event, or may not be associated to an event. The replaying may include a presentation of the obtained snapshot to present an actual graphic replay of the display. This may facilitate presenting the status of components even if no change in the status has occurred to generate an event for the component.

In embodiment, GUI 400 may also include element 416 to enable the operator to specify a number of visualized event messages that are to be replayed (e.g., from the set of event messages) each time a “play button” is pressed. GUI 400 may also include element 418 to enable the operator to specify a speed of the replay of the visualized event messages that are to be replayed when the “play button” is pressed. In this manner, elements 416 and 418 may provide the operator further mechanisms to control the replaying of the visualized event messages.

In embodiment, GUI 400 may include element 419 configured to allow the operator to cause event message compiler 120 to retrieve the compiled set of event messages based on the specified configuration parameters. In this case, upon the operator pressing element 419, event message compiler 120 may connect to database 124 and retrieve the set of event messages from the event log based on the configuration parameters specified (e.g., date/time range, etc.).

In some embodiments, event message compiler 120 may be configured to include, in the compiled set of event messages, a number of events messages with a timestamp prior to the start date/time defined in the configuration parameters. The purpose of this functionality of event message compiler 120 may be to provide some context to the visualization of the first message in the compiled set of event messages. In some cases, simply starting a replay of the event messages from the first event message in the compiled set of event messages may not provide enough context to appreciate the status of the classification yard with respect to the first event. In this case, visualizing a number of prior event messages may provide context to the first event message in the set of event messages.

With reference back to FIG. 1, event analyzer 121 may be configured to analyze the event messages in the set of event messages and to determine a component (e.g., a device of devices 142 or a track segment of segments 144) of classification yard 140 with which each event message may be associated. For example, a first event message in the compiled set of event messages may be analyzed to determine which device or which track segment the event message is associated with. With additional reference to FIG. 2, event analyzer 121 may determine that event message 252, which may be associated with a wheel detection of the 5/8 wheel of a cut at a switch/wheel detector positioned LEFT, may be associated with switch “S1234,” as identified by the source 218 of event message 252. In another example, event analyzer 121 may determine that event message 254, which may be associated with a speed calculation for the cut whose 5/8 wheel was detected at switch/wheel detector “S1234,” may be associated with switch “S1234,” as identified by the source 218 of event message 254. In still another example, event analyzer 121 may determine that event message 264, which may be associated with a speed calculation for the cut whose 6/8 wheel was detected at switch/wheel detector “S1234,” may be associated with switch “S1234,” as identified by the source 218 of event message 264. In yet another example, event analyzer 121 may determine that event message 270, which may be associated with a critical notification of a track foul at a particular track, may be associated with a “distance to coupling” (DTC) source. In each of these cases, and for each event message in the compiled set of event messages, event analyzer 121 may determine a component (e.g., device and/or track segment) of classification yard 140 with which the event message may be associated.

Event message visualizer 122 may be configured to generate a visualization of each event message that is to be replayed in the replay of event messages. In embodiments, visualizing an event message may include generating a visual representation of the event associated with the event message (e.g., the event that occurred at a component of the classification yard that caused the event message to be generated) and overlaying the visual representation of the event onto a graphical representation of the component found (e.g., by event analyzer 121) to be associated with the event message associated with the event. To that end, in embodiments, event message visualizer 122 may generate a graphical schematic diagram of the classification yard. In embodiments, the graphical schematic diagram of the classification yard may include a graphical representation of one or more components (e.g., devices and/or track segments) of the classification yard. In embodiments, the graphical representation of the classification yard may be presented (e.g., displayed) to an operator, such as using GUI 400 as described with respect to FIG. 4A.

FIG. 4B shows an example of a graphical schematic diagram of a classification yard configured in accordance with embodiments of the present disclosure. As shown in FIG. 4B, a graphical schematic diagram 460 of classification yard 140 may be generated by event message visualizer 122 and presented to an operator (e.g., via GUI 400). In embodiments, graphical schematic diagram 460 may include a graphical representation of the various marshalling tracks of classification yard, where the various marshalling tracks are represented by line segments. In particular, graphical schematic diagram 460 may include a graphical representation of the hump section 450, including the hump approach section 452, the hump crest 454, and the release section 456. In embodiments, hump section 450 may graphically represent the physical hump section of classification yard 140. In embodiments, the dimensions in the graphical representation may not be to scale, but the location of each section in the graphical representation may be a representation relative to the physical layout of the hump section. In this manner, hump section 450 may be used to visualize events occurring at components or sections of the hump section.

In embodiments, graphical schematic diagram 460 may include a graphical representation of the various marshalling tracks. In embodiments, the dimensions of the line segments representing the marshalling tracks in the graphical representation may not be to scale, but the location of the line segments representing the marshalling tracks with respect to each other in the graphical representation may be an accurate representation of the location of the physical marshalling tracks in the physical layout of the hump yard. In this manner, the line segments representing the marshalling tracks may be used to visualize events occurring at components or sections on the marshalling tracks.

In embodiments, the marshalling tracks of classification yard 140 may be divided into segments. In embodiments, the line segments representing the marshalling tracks in the graphical representation may be divided into segments as well. In embodiments, the track segments may be defined by switch/wheel detector devices. For example, at switch/wheel detector 462, the segment of the main hump track may be divided into segment 463 and segment 464. In this manner, a cut traveling from the main hump track may be routed (e.g., by switch/wheel detector 462) to one of either segment 463 or segment 464, depending on the position of switch/wheel detector 462. Similarly, at switch/wheel detector 466, segment 464 may be separated into segment 465 and segment 467. In this case, a cut traveling through segment 464 and approaching switch/wheel detector 466 may be routed (e.g., by switch/wheel detector 466) to one of either segment 465 or segment 467. In this example, switch/wheel detector 468 may route a cut to continue along segment 465 or may route a cut from segment 465 into segment 469 toward destination track 472. In this example, each of the segments may be defined as the segment between two switch devices.

In embodiments, graphical schematic diagram 460 may include a graphical representation of the various devices of classification yard 140. For example, a switch device, a detector device, and/or a switch/wheel detector device may be represented in graphical schematic diagram 460 by the identification of the device. For example, switch/wheel detector 468 may be represented by a numerical value indicating the identification of switch/wheel detector 468 (e.g., S1234 in this example). In this manner, a device may be represented in the graphical schematic diagram 460 by its identification. In embodiments, a device may additionally or alternatively, by a special graphical features. For example, in graphical schematic diagram 460, retarder devices may be represented by rectangles. For example, retarder 458 may be represented by a rectangle that is slightly larger than the line segment in which it may be located. In embodiments, destination coupling points (e.g., destination trains to which cuts may be routed) may be represented by a number associated with the destination train.

In embodiments, the graphical representation in graphical schematic diagram 460 of the various devices of classification yard 140 may be positioned within graphical schematic diagram 460 in positions relative to each other that represents the relative position of the physical devices in the physical layout of classification yard 140. In this manner, even if the distances between the graphical representation of the devices is not to scale, the relative position reflects the real-world relative position of the various devices.

In embodiments, event message visualizer 122 may be configured to generate, for each event message in the compiled set of event messages, a visual representation of the event associated with each of the event messages in the compiled set of event messages. In embodiments, an event associated with an event message includes the event that occurred at a component of classification yard and that that caused the event message to be generated. For example, event message visualizer 122 may be configured to generate, for a first event message in the compiled set of event messages, a visual representation of the event associated with the first event message. Event message visualizer 122 may continue generating a visual representation, for each remaining event in the set of event messages, of the event associated with each remaining event.

In embodiments, a visual representation of an event may include a color-based or highlight-based indication to represent the event. For example, a route schedule event may include determining a series of connected segments (e.g., a route) along which a cut being marshalled through the hump is to travel to reach the assigned destination track and train, and may be generated as the cut is leaving the hump section. In this case, a visual representation of the route schedule event may include highlighting the scheduled route (e.g., the track segments making up the route) in a particular color (e.g., green) to indicate a scheduled route. In embodiments, a visual representation of an occupancy event (e.g., an event in which a track segment is found to be occupied by a cut, such as based on a detection of a cut at a wheel detector positioned at the entry point of the segment) may include highlighting the occupied track segment in a particular color (e.g., red) to indicate that the track segment is occupied. In some embodiments, events related to a track segment being closed (e.g., an event in which the result is that a track segment cannot be traversed by a cut, such as by a defective component within the segment, a closed retarder, etc.) may also be represented visually using a color-coded indication (e.g., red or yellow).

In embodiments, a visual representation of an event may include a representation of an identification of a component. For example, in embodiments, an event may include an identification of a cut being detected at an identification detector. In these embodiments, a visual representation of the identification event may include displaying a message indicating the identification of the detected cut.

In embodiments, a visual representation of an event may include a numerical representation associated with the event. In embodiments, the numerical representation may include a detected speed of a cut. For example, in embodiments, an event may include a speed calculation event for a detected cut. In these embodiments, a visual representation of the identification event may include displaying a numerical representation of the speed of the detected cut based on the calculated speed in the event message associated with the event. In embodiments, the numerical representation may include an indication of a specific wheel of a cut detected. For example, in embodiments, an event message associated with a wheel detection event may include an indication of the specific wheel of the cut detected (e.g., may include an indication that the fourth wheel of eight total wheels of the cut was detected). In this case, a visual representation of the wheel detection event may include displaying a numerical representation of the specific wheel of the cut detected based on the indication in the event message associated with the event.

It is noted that the description herein with respect to visual representations that may be generated for various events is not intended to be exhaustive and/or limiting in any way. Indeed, many other types of visual representations for many other types of events may be generated, and the present description is intended to be illustrative and not limiting.

In embodiments, event message visualizer 122 may be configured to overlay the visual representation generated for each event onto the graphical representation of the component found (e.g., by event analyzer 121) to be associated with each event message associated with the event to visualize each event. For example, event message visualizer 122 may be configured to display the visual representation for each event over the graphical representation of the component associated with each event message associated with the event. In this manner, the visual representation for an event may be shown in relation to the component in which the event occurred. FIG. 4C shows an example of an overlay of a visual representation of an event over the components associated with the event in accordance with embodiments of the present disclosure.

The example illustrated in FIG. 4C may include a route schedule event. In this case, cut 480, which may be currently (e.g., at the time the route schedule event occurred) occupying the hump section and is about to leave the hump section, may be scheduled to travel along route 482 to destination train 484. In this example, a visual representation, which may include a color-based highlight, may be displayed over the track segments making up route 482. In this case, the result is that route 482 is highlighted in a particular color (e.g., green). In this manner, the visual representation of the route schedule event that occurred for the cut may be overlaid onto the track segments of the route to visualize the route schedule event.

In the example illustrated in FIG. 4C, cut 480 is found to be occupying the release section of the hump section (e.g., the hump release retarder). In this case, this occupancy event may be represented by a color-based visual representation that may include displaying an indication of a particular color (e.g., red) to indicate that event is that the hump release retarder is occupied. In this manner, the visual representation of the occupancy event that occurred at the hump release retarder may be overlaid onto the hump release retarder to visualize the occupancy event.

FIG. 4D shows another example of an overlay of a visual representation of an event over the components associated with the event in accordance with embodiments of the present disclosure. In one example, FIG. 4D illustrates an occupancy event at track segment 486. In this example, a color-based visual representation (e.g., a red highlight) may be overlaid or displayed over the graphical representation of track segment 486 to show the occupancy event occurring at track segment 486.

In another example, FIG. 4D illustrates a wheel detection event that occurred at wheel detector 485. In this example, a numerical-based visual representation may be overlaid or displayed proximate to the graphical representation of wheel detector 485 to show the wheel detection event occurring at wheel detector 485. In particular, the graphical representation of wheel detector 485 may include a displaying the identification (e.g., “2135”) of wheel detector 485. In this same example, the wheel detection event included detecting the fifth wheel of the cut passing through wheel detector 485. In this case, the visual representation of the wheel detection event at wheel detector 485 includes a numerical value of “5” (e.g., to show that the detection is of the fifth wheel of the cut), which may be displayed next to the identification of wheel detector 485. In this manner, the visual representation of the wheel detector event that occurred at wheel detector 485 may be overlaid onto wheel detector 485 to visualize the wheel detection event.

In another example, FIG. 4D illustrates a speed calculation event that occurred for the wheel detected at wheel detector 485 (e.g., to calculate the speed of the cut passing through the wheel detector 485). In this example, a numerical-based visual representation may be overlaid or displayed proximate to the graphical representation of wheel detector 485 to show the speed calculation event occurring at wheel detector 485. In this case, the visual representation of the speed calculation event at wheel detector 485 includes a numerical value of “8.10” (e.g., representing a speed of 8.1 MPH of the cut detected at wheel detector 485), which may be displayed next to the identification of wheel detector 485. In this manner, the visual representation of the speed calculation event that occurred at wheel detector 485 may be overlaid onto wheel detector 485 to visualize the speed calculation event.

In another example, FIG. 4D illustrates a notification event in which a critical event that occurred at classification yard 140 may be represented by a notification message 493 displayed in critical section 492, which may be configured for displaying critical notifications associated with critical notification events that are present in the compiled set of event messages. A section 494 may also be provided for displaying non-critical notifications associated with non-critical notification events.

With reference back to FIG. 1, replay manager 123 may be configured to display the overlays generated for each of the event messages in the compiled set of event messages sequentially, based on the timestamps associated with each event message, to replay the visualized events associated with the event messages in the graphical user interface. In this manner, an operator may view the visual representations of the events associated with the event messages in the compiled set of event messages in the order that the events occur at the various components of the classification yard.

In embodiments, as seen in FIG. 4D, replay controls 490 may be provide a control mechanism that may be provided to the operator for controlling the replay speed, the number of events that are played each time the replay is played, for pausing the replay, for rewinding the replay, etc.

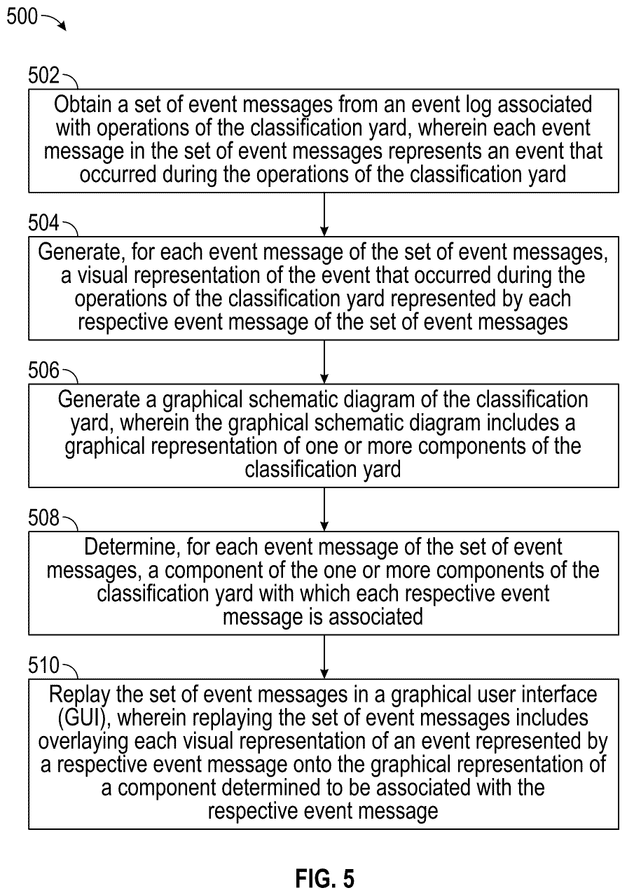

FIG. 5 shows a high-level flow diagram 500 of operation of a system configured in accordance with embodiments of the present disclosure for providing functionality for visualizing event data associated with operations of a classification yard. For example, the functions illustrated in the example blocks shown in FIG. 5 may be performed by system 100 of FIG. 1 according to embodiments herein. In embodiments, the operations of the method 500 may be stored as instructions that, when executed by one or more processors, cause the one or more processors to perform the operations of the method 500.

At block 502, a set of event messages is obtained from an event log associated with operations of the classification yard. In embodiments, each event message in the set of event messages may represent an event that occurred during the operations of the classification yard. In embodiments, functionality of an event message compiler (e.g., event message compiler 120 in FIG. 1) may be used to obtain a set of event messages from an event log associated with operations of the classification yard. In embodiments, the event message compiler may perform operations to obtain a set of event messages from an event log associated with operations of the classification yard according to operations and functionality as described above with reference to event message compiler 120 and as illustrated in FIGS. 1-4.

At block 504, a visual representation of the event that occurred during the operations of the classification yard represented by each respective event message of the set of event messages is generated for each event message of the set of event messages. In embodiments, functionality of an event message visualizer (e.g., event message visualizer 122 in FIG. 1) may be used to generate, for each event message of the set of event messages, a visual representation of the event that occurred during the operations of the classification yard represented by each respective event message of the set of event messages. In embodiments, the event message visualizer may perform operations to generate, for each event message of the set of event messages, a visual representation of the event that occurred during the operations of the classification yard represented by each respective event message of the set of event messages according to operations and functionality as described above with reference to event message visualizer 122 and as illustrated in FIGS. 1-4.

At block 506, a graphical schematic diagram of the classification yard is generated. In embodiments, the graphical schematic diagram includes a graphical representation of one or more components of the classification yard. In embodiments, functionality of an event message visualizer (e.g., event message visualizer 122 in FIG. 1) may be used to generate a graphical schematic diagram of the classification yard. In embodiments, the event message visualizer may perform operations to generate a graphical schematic diagram of the classification yard according to operations and functionality as described above with reference to event message visualizer 122 and as illustrated in FIGS. 1-4.

At block 508, a component of the one or more components of the classification yard with which each respective event message is associated is determined for each event message of the set of event messages. In embodiments, functionality of an event analyzer (e.g., event analyzer 121 in FIG. 1) may be used to determine, for each event message of the set of event messages, component of the one or more components of the classification yard with which each respective event message is associated. In embodiments, the event analyzer may perform operations to determine, for each event message of the set of event messages, component of the one or more components of the classification yard with which each respective event message is associated according to operations and functionality as described above with reference to event analyzer 121 and as illustrated in FIGS. 1-4.

At block 510, the set of event messages is replayed in a GUI. In embodiments, replaying the set of event messages includes overlaying each visual representation of an event represented by a respective event message onto the graphical representation of a component determined to be associated with the respective event message. In embodiments, cooperative functionality of an event message visualizer (e.g., event message visualizer 122 in FIG. 1) and replay manager (e.g., replay manager 123 in FIG. 1) may be used to replay the set of event messages in a GUI. In embodiments, the event message visualizer and the replay manager may perform operations to replay the set of event messages in a GUI according to operations and functionality as described above with reference to event message visualizer 122 and replay manager 123, and as illustrated in FIGS. 1-4.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-5 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of visualizing event data associated with operations of a classification yard, comprising:
obtaining a set of event messages from an event log associated with operations of the classification yard, wherein each event message in the set of event messages represents an event that occurred during the operations of the classification yard;
generating, for each event message of the set of event messages, a visual representation of the event that occurred during the operations of the classification yard represented by each respective event message of the set of event messages;
generating a graphical schematic diagram of the classification yard, wherein the graphical schematic diagram includes a graphical representation of one or more components of the classification yard;
determining, for each event message of the set of event messages, a component of the one or more components of the classification yard with which each respective event message is associated; and
replaying the set of event messages in a graphical user interface (GUI), wherein replaying the set of event messages includes overlaying each visual representation of an event represented by a respective event message onto the graphical representation of a component determined to be associated with the respective event message.

2. The method of claim 1, wherein each event message in the set of event messages is associated with one or more devices of the classification yard.

3. The method of claim 1, wherein the one or more components of the classification yard includes one or more of:
a switch device;
a wheel detector device;
a retarder device;
a distance to coupling sensor;
a radar sensor;
a track segment of the classification yard;
a control component of the classification yard;
an occupancy device; and
a notification component of the classification yard.

4. The method of claim 1, wherein the graphical representation of the one or more components of the classification yard includes positioning each component of the one or more components on a location within the graphical schematic diagram of the classification yard corresponding to a generally relative physical location of each component of the one or more components on the physical layout of the classification yard.

5. The method of claim 1, wherein the visual representation of the event that occurred during the operations of the classification yard represented by each respective event message of the set of event messages includes one or more of:
a color-based indication of the respective event;
a numerical indication of the respective event; and
a size-based indication of the respective event.

6. The method of claim 5, wherein the color-based indication of the respective event includes highlighting the graphical representation of the component determined to be associated with the respective event message associated with the respective event with a color to indicate the event.

7. The method of claim 5, wherein the numerical indication of the respective event includes displaying a numerical value proximate the graphical representation of the component determined to be associated with the respective event message associated with the respective event indicating a value associated with the event.

8. The method of claim 1, wherein replaying the set of event messages in the GUI includes replaying each of the event messages in the set of events messages in sequence based on a timestamp associated with each respective event message in the set of events messages.

9. The method of claim 8, wherein obtaining the set of event messages from the event log includes determining a time-based range specifying a range of events messages to be included in the set of event messages based on the based on the timestamp associated with each event message in the set of events messages.

10. The method of claim 1, wherein determining the component with which each respective event message is associated includes:
determining a type for each of the event messages in the set of event messages;
determining a communications module configured to handle each respective type for each of the event messages in the set of event messages; and
tasking, for each of event message in the set of event messages, a respective communications module to determine the one or more components of the classification yard with which each respective event message of the type the respective communications module is configured to handle is associated.

11. A system for visualizing event data associated with operations of a classification yard, comprising:
at least one processor; and
a memory operably coupled to the at least one processor and storing processor-readable code that, when executed by the at least one processor, is configured to perform operations including:
obtaining a set of event messages from an event log associated with operations of the classification yard, wherein each event message in the set of event messages represents an event that occurred during the operations of the classification yard;
generating, for each event message of the set of event messages, a visual representation of the event that occurred during the operations of the classification yard represented by each respective event message of the set of event messages;
generating a graphical schematic diagram of the classification yard, wherein the graphical schematic diagram includes a graphical representation of one or more components of the classification yard;
determining, for each event message of the set of event messages, a component of the one or more components of the classification yard with which each respective event message is associated; and
replaying the set of event messages in a graphical user interface (GUI), wherein replaying the set of event messages includes overlaying each visual representation of an event represented by a respective event message onto the graphical representation of a component determined to be associated with the respective event message.

12. The system of claim 11, wherein each event message in the set of event messages is associated with one or more devices of the classification yard.

13. The system of claim 11, wherein the one or more components of the classification yard includes one or more of:
a switch device;
a wheel detector device;
a retarder device;
a distance to coupling sensor;
a radar sensor;
a track segment of the classification yard;
a control component of the classification yard;
an occupancy device; and
a notification component of the classification yard.

14. The system of claim 11, wherein the graphical representation of the one or more components of the classification yard includes positioning each component of the one or more components on a location within the graphical schematic diagram of the classification yard corresponding to a generally relative physical location of each component of the one or more components on the physical layout of the classification yard.

15. The system of claim 11, wherein the visual representation of the event that occurred during the operations of the classification yard represented by each respective event message of the set of event messages includes one or more of:
a color-based indication of the respective event;
a numerical indication of the respective event; and
a size-based indication of the respective event.

16. The system of claim 11, wherein replaying the set of event messages in the GUI includes replaying each of the event messages in the set of events messages in sequence based on a timestamp associated with each respective event message in the set of events messages.

17. The system of claim 16, wherein obtaining the set of event messages from the event log includes determining a time-based range specifying a range of events messages to be included in the set of event messages based on the based on the timestamp associated with each event message in the set of events messages.

18. The system of claim 11, wherein determining the component with which each respective event message is associated includes:
determining a type for each of the event messages in the set of event messages;
determining a communications module configured to handle each respective type for each of the event messages in the set of event messages; and
tasking, for each of event message in the set of event messages, a respective communications module to determine the one or more components of the classification yard with which each respective event message of the type the respective communications module is configured to handle is associated.

19. A computer-based tool for visualizing event data associated with operations of a classification yard, the computer-based tool including non-transitory computer readable media having stored thereon computer code which, when executed by a processor, causes a computing device to perform operations comprising:
obtaining a set of event messages from an event log associated with operations of the classification yard, wherein each event message in the set of event messages represents an event that occurred during the operations of the classification yard;
generating, for each event message of the set of event messages, a visual representation of the event that occurred during the operations of the classification yard represented by each respective event message of the set of event messages;
generating a graphical schematic diagram of the classification yard, wherein the graphical schematic diagram includes a graphical representation of one or more components of the classification yard;
determining, for each event message of the set of event messages, a component of the one or more components of the classification yard with which each respective event message is associated; and
replaying the set of event messages in a graphical user interface (GUI), wherein replaying the set of event messages includes overlaying each visual representation of an event represented by a respective event message onto the graphical representation of a component determined to be associated with the respective event message.

20. The computer-based tool of claim 19, wherein the graphical representation of the one or more components of the classification yard includes positioning each component of the one or more components on a location within the graphical schematic diagram of the classification yard corresponding to a generally relative physical location of each component of the one or more components on the physical layout of the classification yard.
